(19) United States
(12) Patent Application Publication
(10) Pub. No.: US 2004/0243404 A1
(43) Pub. Date: Dec. 2, 2004

(54) Method and apparatus for improving voice quality of encoded speech signals in a network

(76) Inventors: Juergen Cezanne, Tinton Falls, NJ (US); Chin-Sheng Chuang, Holmdel, NJ (US); Walter Etter, Wayside, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/449,288

(22) Filed: May 30, 2003

(51) Int. Cl. G10L 19/14

(52) U.S. Cl. 704/225

(57) ABSTRACT

Voice quality enhancement is performed in the network directly on the bit stream of encoded speech in order to avoid additional speech decoding/encoding in the network signal path. Partial or complete decoding is used to analyze the speech signal and to provide information to a bit-stream based speech processing unit. In general, only selected bits are modified in the bit stream, e.g., the excitation gain or the vocal tract parameters, while the remaining bits remain unchanged. No decoding and encoding is required in the network signal path and, as such, tandem free operation is supported. In one exemplary embodiment, voice quality enhancements such as noise compensation, noise reduction, automatic level control, and acoustic echo control are performed on the bit stream.

### TECHNICAL FIELD

The present invention relates generally to voice quality enhancements of speech signals and, more specifically, to voice quality enhancements performed in the network.

### BACKGROUND OF THE INVENTION

Cellular phones and networks employ speech codecs to reduce the data rate in order to make efficient use of the bandwidth resources in the radio interface. In a mobile-to-mobile call, the PCM (pulse code modulation) speech signal is first encoded into a lower-rate bit stream by the speech codec of mobile A, transmitted over the network, and then decoded back into a PCM signal in the speech codec of mobile B.

Speech codecs are also used in Internet-based transmission in conjunction with IP (Internet Protocol) phones. As in cellular phones, the reduced data rate due to speech codecs allows for more throughput, that is, more telephone conversation, for a given transmission medium.

In recent years, several measures have been taken to improve the voice quality of wireless communication. One improvement stems from enhancing speech codecs. For example, in the well known European cellular phone standard GSM, the Full Rate (FR) codec was supplemented with the Enhanced Full Rate (EFR) codec, a codec with better voice quality. Another improvement resulted from introducing network equipment that supports Tandem Free Operation (TFO) or Transcoder Free Operation (TrFO). These techniques are intended to avoid traditional double encoding/decoding in a mobile-to-mobile call. Without TFO or TrFO, the network first decodes the bit stream from a mobile station A into a regular PCM signal and then encodes it again before transmission over the air link to a mobile station B. In the case of a mobile-to-mobile call, encoding and decoding in the network is completely unnecessary. In fact, the resulting double (or tandem) encoding/decoding degrades the voice quality. Standards have been finalized to enable tandem free or transcoder free operation, see, e.g., ETSI 3GPP TS 23.153, “Out of band transcoder control” and ETSI 3GPP TS 28.062, “Inband Tandem Free Operation (TFO) of speech codecs”.

Signal processing to enhance voice communication can be performed in the terminal, e.g., cell phone, land phone, and so on, or in the network, e.g., BTS (Base Transceiver Station), BSC (Base Station Controller), MSC (Mobile Switching Center). In the terminal, the near-end and far-end PCM signals are accessible. In network equipment that supports TFO or TrFO, both the near-end and far-end PCM signals may not be accessible directly, but rather only their corresponding bit streams of the encoded signals may be accessible.

In conventional methods, voice quality enhancements such as acoustic echo control, noise compensation, noise reduction, and automatic gain control, is solely performed on PCM speech signals. When such signal processing is performed in the network, tandem free operation or transcoder free operation is no longer possible. As a result of double speech encoding/decoding, speech quality is always degraded, making network-located signal processing and signal enhancement less appealing. Yet, it would be desirable to perform signal enhancement in the network for economic reasons. For example, when signal enhancement is implemented in the mobile station, the additional computational load drains the battery more quickly, thus requiring frequent recharging. When implemented in the network, such drawbacks do not exist. In addition, computational resources can be shared in the network among users, thus making even complex algorithms economical. For these reasons, a network-based voice quality enhancement method, which avoids conventional double speech encoding/decoding problems, is desirable.

Furthermore, conventional methods provide either TFO/TrFO without voice quality enhancement, or voice quality enhancement without TFO/TrFO. Conventional methods do not allow for combined TFO/TrFO and voice quality enhancement.

### SUMMARY OF THE INVENTION

The shortcomings of the prior art are overcome according to the principles of the invention in a method that both supports tandem free or transcoder free operation and implements voice quality enhancements in the network. By supporting tandem free or transcoder free operation, double encoding/decoding and the resultant degradation of voice quality is avoided. By implementing voice quality enhancements such as acoustic echo suppression, noise reduction, noise compensation, and/or automatic level control directly in the network, problems associated with performing these functions in the mobile station are also avoided, e.g., computational and power drain on the mobile station and so on.

According to one illustrative embodiment, voice quality enhancement is performed by modifying the bit stream of the encoded speech directly in order to avoid additional speech decoding/encoding in the network. Partial or complete decoding of the bit stream, which is done in the network but in a non-intrusive manner separate from the main signal path, is used to analyze the speech signal and to provide information to a bit-stream based speech processing unit, which then modifies the bit stream accordingly. In general, only selected bits are modified in the bit stream, e.g., the excitation gain or the vocal tract parameters, while the remaining bits remain unchanged. No decoding and encoding is performed in the main signal path, thus supporting tandem free operation. In an exemplary embodiment of the invention, one or more voice quality enhancements such as noise compensation, noise reduction, automatic level control, and acoustic echo control are performed on the bit stream.

### BRIEF DESCRIPTON OF THE DRAWINGS

A more complete understanding of the present invention may be obtained from consideration of the following detailed description of the invention in conjunction with the drawing, with like elements referenced with like reference numerals, in which:

FIG. 1 is a block diagram illustrating conventional signal processing in a network;

FIG. 2 is a block diagram illustrating conventional Tandem Free Operation (TFO);

FIG. 3 is a block diagram illustrating an exemplary embodiment for implementing bit stream processing in the network according to the principles of the invention;

FIG. 4 is a block diagram illustrating an exemplary embodiment of the bit stream processor shown in FIG. 3 according to the principles of the invention;

FIG. 5 is a flow diagram for bit stream noise compensation according to one illustrative embodiment of the invention;

FIG. 6 is a flow diagram for bit stream automatic level control according to one illustrative embodiment of the invention;

FIG. 7 is a flow diagram for bit stream acoustic echo control according to one illustrative embodiment of the invention; and

FIG. 8 is a flow diagram for bit stream noise reduction according to one illustrative embodiment of the invention.

### DETAILED DESCRIPTION

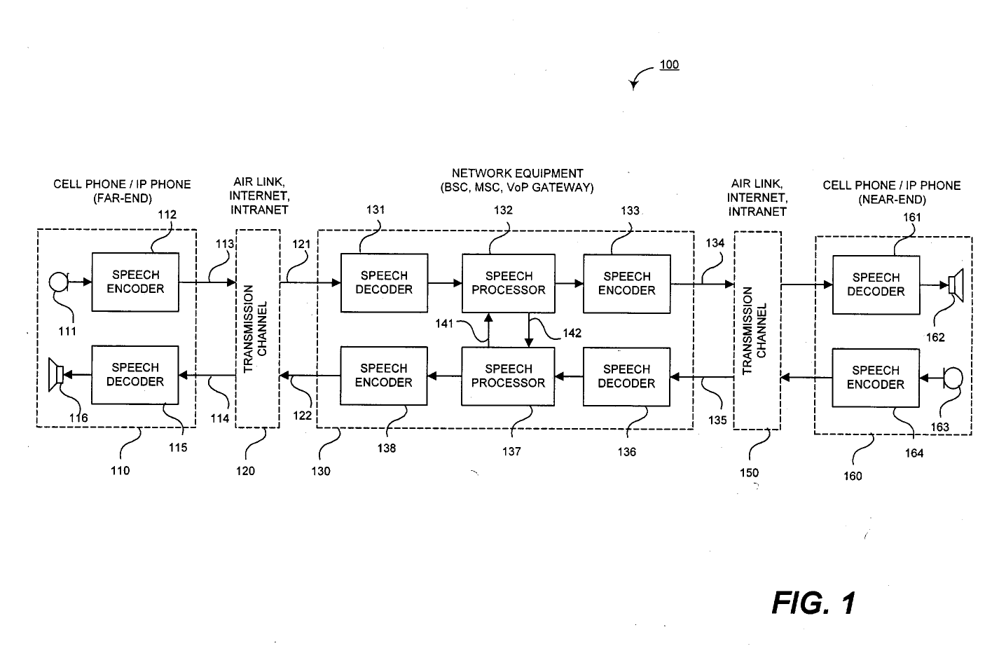

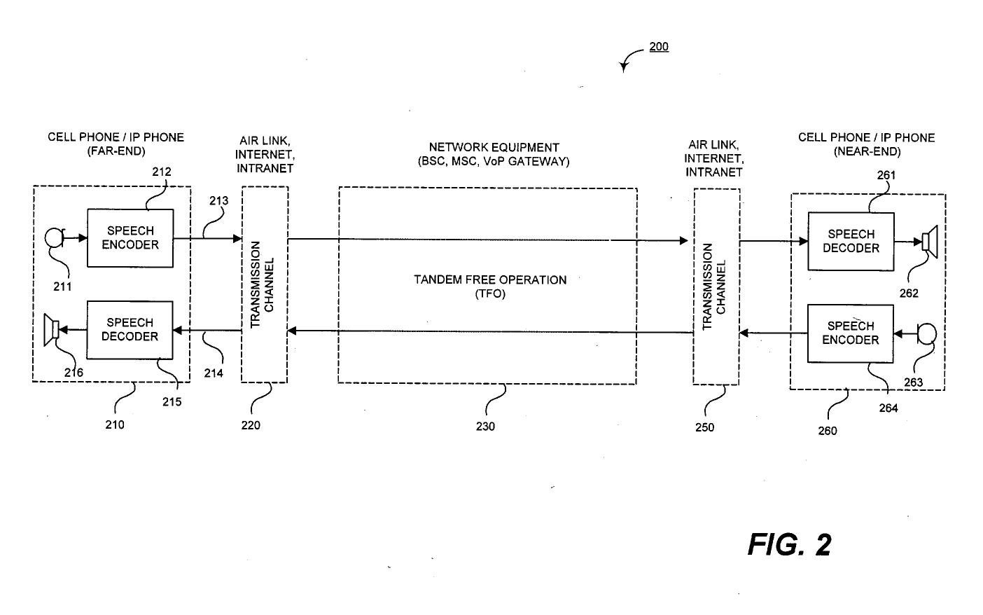

Before describing specific illustrative embodiments of the invention, a brief description of a conventional network, conventional speech processing, and conventional tandem free/transcoder free operation will be provided with reference to FIGS. 1 and 2. This background detail will be helpful to better understanding the improvements provided by the inventive concepts set forth later in the description.

In conventional techniques, signal processing to enhance speech quality is solely performed on the speech signal in linear PCM format. We have recognized that, in a corresponding manner, signal processing can also be performed on the encoded bit stream itself, thus avoiding undesirable tandem operation of speech codecs. Such bit stream processing has significant advantages over traditional signal processing. It provides better voice quality at a reduced complexity and also supports tandem free operation (TFO) and transcoder free operation (TrFO). In other words, cascading of two or more speech codecs (i.e., encode-decode-encode-decode- . . . ) is avoided. For example, in a connection from a far-end cell phone to a near-end IP phone, best speech quality is achieved if the near-end speech is encoded only once in the cell phone and decoded only once in the IP phone. The same is true for the reverse direction. Unfortunately, conventional techniques unnecessarily decode and encode speech in the network, leading to degraded voice quality.

FIG. 1 illustrates conventional signal processing that takes place in the network (i.e., network-located). As shown and as will be described in further detail, the signals undergo additional encoding/decoding in the network (e.g., in the network equipment), thus leading to tandem operation of speech codecs or double encoding/decoding in the end-to-end transmission path. Exemplary communication system 100 includes phones 110 and 160 (cellular and/or IP), transmission channels 120 and 150, and network equipment 130. For sake of brevity and ease of illustration, communication system 100 is only shown to include elements that are relevant to describing the invention. For example, analog-to-digital and digital-to-analog converters, channel coders, and radio frequency modulators are not shown. However, these and other elements that would typically be part of communication system 100 are well known to those skilled in the art.

Considering the upper signal path, the speech signal picked up by microphone 111 passes through speech encoder 112, transmission channel 120, speech decoder 131, speech processor 132, speech decoder 133, transmission channel 150, and speech decoder 161 before finally arriving at loudspeaker 162. As shown, two speech encoders and two speech decoders are directly in the signal path. As a result, tandem speech coding occurs, which is undesirable, since each added pair of encoder/decoder degrades the speech quality. If speech processor 132 was not used in the network, speech decoder 131 and speech encoder 133 would not be necessary. However, to perform speech processing, conventional methods employ speech decoding to provide a speech signal in PCM format to speech processor 132, and speech encoding to transmit speech further. As a result of the operation of speech decoder 131 and speech encoder 133, generally all the bits in bit stream 134 are modified from the original bit stream 121. Accordingly, a method for speech processing in the network and which only modifies selected bits in the bit stream in order to avoid degradation of the speech quality is desired. Such a method is described below according to illustrative embodiments of the invention.

FIG. 2 illustrates tandem free operation in conventional systems. Similar elements are included in communication system 200 as in communication system 100 in FIG. 1. For example, communication system 200 includes phones 210 and 260, transmission channels 220 and 250, and network equipment 230. However, in communication system 200, only one encoder and only one decoder is used in a microphone-to-loudspeaker signal path (e.g., encoder 212 and decoder 261 or encoder 264 and decoder 215). Therefore, network equipment 230 is working in tandem free operation (TFO) mode, in which the encoded speech signals are passed on and no speech codecs are being applied in network equipment 230. TFO mode is well known to those skilled in the art and standards committees have written specifications for tandem free operation (TFO), e.g., in “Base Station Controller—Base Transceiver Station Layer 3 specifications, ETSI 3GPP TS 48.058”. Although such conventional tandem free operation does not degrade speech quality (i.e., because double encoding/decoding is avoided), it also does not allow for enhancing the voice quality in the network.

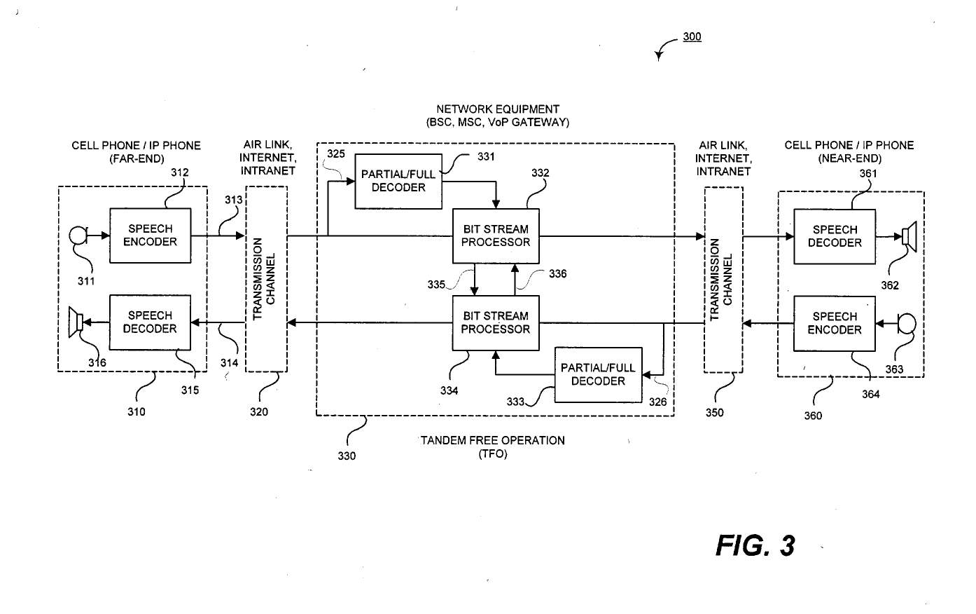

FIG. 3 shows one illustrative embodiment of a system 300 utilizing bit stream processing (BSP) according to the principles of the invention. As shown, system 300 includes phones 310 and 360, transmission channels 320 and 350, and network equipment 330. The components and functions applicable to phones 310, 360 and transmission channels 320, 350 are the same as in the preceding FIGS. 1 and 2 and will not be repeated here for sake of brevity. However, the composition and functions of network equipment 330 will be described to illustrate the principles of the invention. As shown, network equipment 330 includes a bit stream processor 332 and 334 in each of the transmission paths between far-end phone 310 and near-end phone 360. (It should be noted that near-end and far-end are arbitrarily selected in the example shown in FIG. 3). Additionally, network equipment 330 further comprises a partial/full decoder 331 and 333 in control paths 325 and 326, respectively. In general, each of partial/full decoders 331 and 333 is coupled to respective bit stream processors 332 and 334, such that the partial/full decoders 331 and 333 process the bit stream being input to the respective bit stream processors 332 and 334 as will be described in further detail below.

Processing is performed directly on the bit stream, that is, no additional decoder and encoder is located in the direct transmission path. Instead, only a partial or full decoder 331 (333) is used in a control path that is separate from the transmission path. In this manner, partial or full decoder 331 (333) can be used to extract the signal parameters or signal components in a non-intrusive manner in contrast to the example shown in FIG. 1 in which the decoders/encoders were processing the signal in the main transmission path.

The selection of a partial or full decoder may depend on the functionality required, e.g., noise reduction, noise compensation, and so on. It may also depend on the required performance. The additional information obtained by a full decoder may potentially allow to increase the performance of a bit stream algorithm. If a bit stream algorithm requires only a subset of speech variables, such as the fixed codebook excitation gain for example, then a partial decoder may be applied. A partial decoder performs at least the task of assembling a pre-defined subset of bits in the bit stream to reconstruct the corresponding speech variable. Such a speech variable is then represented, for example, in 16-bit integer form. For some bit stream algorithms, it may be advantageous if the speech signal is completely reconstructed from the encoded bit stream, in which case a full decoder is needed in the control path. A partial decoder will provide at least one speech parameter, while a full decoder will not only provide all speech parameters including the excitation, but also the reconstructed speech signal. A full decoder may also facilitate the re-use of a conventional speech processing algorithm that takes PCM samples as input. On the other hand, a full decoder increases the requirements for computational resources. Oftentimes, a bit stream algorithm can be designed in both ways, such that it either requires a full decoder or only a partial decoder. Accordingly, two exemplary Automatic Level Control (ALC) bit stream algorithms using either approach will be described with reference to the embodiment shown in FIG. 3.

The bit stream processor (or bit stream modification unit) 332 (334) uses the control information provided by the partial/full decoder to calculate the modification to the bit stream. Generally, only selected bits are modified in the bit stream, unlike in conventional techniques, where a decoder and encoder in the signal path would typically modify the entire bit stream. Both bit stream processors 332 and 334 share information via connections/links 335 and 336. Information sharing to account for far-end and near-end signal statistics is typically required in algorithms such as acoustic echo control and noise compensation. As can be seen in FIG. 3, system 300 combines the advantages of transmission systems 100 and 200 whereby tandem coding is avoided and voice quality enhancement is provided.

FIG. 3 illustrates the most general scenario, in which case both far-end and near-end speech signals run through a bit stream processor. In simplified systems, only one signal path (near-end or far-end) might contain a bit stream processor. Such a simplified system may require only one partial/full decoder, for example, when the bit stream processor performs noise reduction or automatic level control. For other bit stream processing tasks, such as acoustic echo control or noise compensation, a simplified system with only one bit stream processor may still require a partial/full decoder for both near-end and far-end signals. Again, the particular arrangement of components will be a matter of design choice and will be apparent to one skilled in the art when viewed in the context of the teachings of the invention.

It should be understood that bit stream processing in network equipment 330 may be used in a subsystem of a communications network, such as a Base Controller Station (BSC), a Mobile Switching Center (MSC), a Voice over Packet (VoP) gateway or any other communications network. It should be further understood that although the terms “far-end” and “near-end” are typically associated with the implementation in a network device, the terms “far-end” and “near-end” are not subject to such a narrow interpretation. To generalize, the terms “far-end” and “near-end” may be replaced by the terms “A-side” and “B-side”, by way of example.

As is well known, the most prevailing models used in speech codecs (also referred to as speech coders) are based on linear prediction (LP). In this model, the vocal tract is estimated in the speech encoder using linear prediction on a frame-by-frame basis. The speech frame to be encoded is then filtered with the vocal tract inverse filter to provide the excitation. The excitation may consist of two parts, the glottal pulse or pitch signal (voiced phonemes) and a noise-like signal (unvoiced phonemes). In other words, the task of the speech encoder is to extract the LP parameters and the excitation parameters. By transmitting only these parameters, the data rate is reduced significantly. For example, instead of transmitting a 64 kbit/s speech signal (8-bit mu-law speech signal sampled at 8 kHz), the data rate is reduced to about 5 to 12 kbit/s for current speech codecs.

To give a practical example of bit stream processing, we consider the Adaptive Multi-Rate (AMR) codec. The standard applicable to this codec is described in ETSI 3GPP TS 26.090: “AMR Speech Codec; Speech transcoding”. For a more detailed coverage of speech coding principles, the reader is referred to “Speech coding and synthesis,” edited by W. B. Kleijn and K. K. Paliwal, published by Elsevier, 2^{nd} ed., 1998. In the example of an AMR codec, Table 1 shows the bit allocation in the 12.2 kbit/s mode. The speech signal, which has been sampled at a rate of 8 kHz, is segmented by the AMR codec into 20 ms frames consisting of 160 PCM samples. For each frame, the encoder determines 244 bits shown in Table 1, which are transmitted to the receiver.

TABLE 1
AMR encoder output bit stream for a frame of 20 ms (12.2 kbit/s mode).

| Bits (MSB-LSB) | Description |
|---|---|
| s1-s7 | index of 1st LSF submatrix |
| s8-s15 | index of 2nd LSF submatrix |
| s16-s23 | index of 3rd LSF submatrix |
| s24 | sign of 3rd LSF submatrix |
| s25-s32 | index of 4th LSF submatrix |
| s33-s38 | index of 5th LSF submatrix |
| subframe 1 | |
| s39-s47 | adaptive codebook index |
| s48-s51 | adaptive codebook gain |
| s52 | sign information for 1st and 6th pulses |
| s53-s55 | position of 1st pulse |
| s56 | sign information for 2nd and 7th pulses |
| s57-s59 | position of 2nd pulse |
| s60 | sign information for 3rd and 8th pulses |
| s61-s63 | position of 3rd pulse |
| s64 | sign information for 4th and 9th pulses |
| s65-s67 | position of 4th pulse |
| s68 | sign information for 5th and 10th pulses |
| s69-s71 | position of 5th pulse |
| s72-s74 | position of 6th pulse |
| s75-s77 | position of 7th pulse |
| s78-s80 | position of 8th pulse |
| s81-s83 | position of 9th pulse |
| s84-s86 | position of 10th pulse |
| s87-s91 | fixed codebook gain |
| subframe 2 | |
| s92-s97 | adaptive codebook index (relative) |
| s98-s141 | same description as s48-s91 |
| subframe 3 | |
| s142-s194 | same description as s39-s91 |
| Subframe 4 | |
| s195-s244 | same description as s92-s141 |

A frame is further divided into four subframes as shown in Table 1. The parameters in Table 1 consist of the line spectral frequencies (LSF) (also called line spectral pairs), which are allocated to bits s1-s38. These parameters are determined once per frame only, while the remaining parameters are determined for each subframe. The LSF parameters are a particular representation of the LP parameters, which were discussed previously. The remaining bits s39-s244 determine the excitation. They can be divided into fixed codebook (or fixed codebook excitation) and adaptive codebook (or adaptive codebook excitation) parameters. The fixed codebook contains the noise-like component, while the adaptive codebook contains the pitch information.

In bit stream processing generally, only a selected number of bits are modified. For example, a bit stream algorithm for noise compensation, acoustic echo suppression, or automatic gain control may only modify the fixed codebook gain, that is, bit s87-s91, s137-s141, s190-s194, and s240-s244. In contrast to modification of the excitation, a bit stream algorithm for noise reduction may only modify the LSF parameters bit s1-s38.

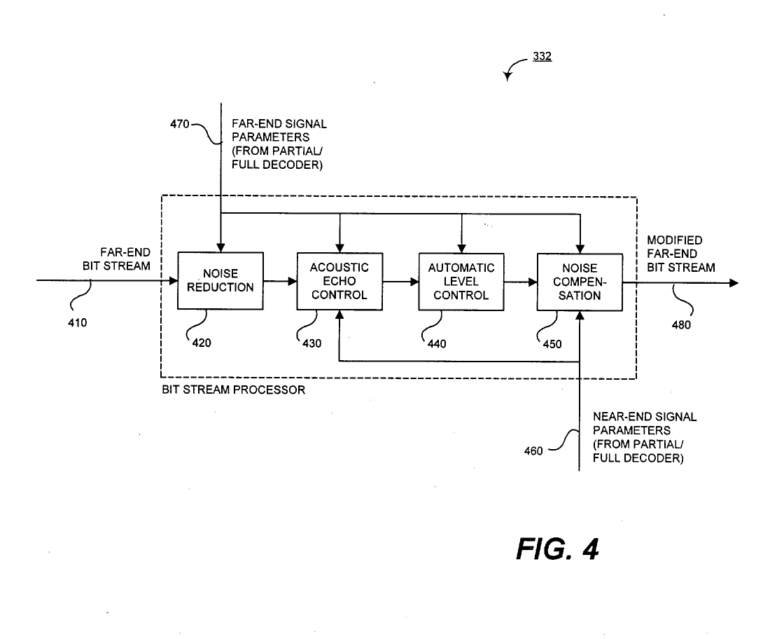

FIG. 4 shows one illustrative embodiment of the bit stream processor 332 shown in FIG. 3. Similarly, bit stream processor 334 in FIG. 3 can also be implemented according to the illustrative embodiment shown in FIG. 4. More specifically, FIG. 4 illustrates the different voice quality enhancement functions that can be implemented in bit stream processor 332 (334). In contrast to known arrangements, such as that shown in FIG. 1 where the speech processor operates on the PCM speech signal itself, bit stream processor 332 according to the principles of the invention operates directly on the bit stream to process the encoded speech.

In the exemplary embodiment shown in FIG. 4, bit stream processor 332 includes a noise reduction unit 420, acoustic echo control unit 430, automatic level control unit 440, and noise compensation unit 450, all of which are exemplary functional units provided by a bit stream processing system. Bit stream processor 332 receives and processes input bit stream 410 (e.g., from far-end phone 310 and transmission channel 320) to provide the modified bit stream 480 at the output. In this example, sub-processing units 420, 430, 440, and 450 receive control input from the far-end side signal parameters 470 generated by partial/full decoder 331 (FIG. 3). The acoustic echo control unit 430 and the noise compensation unit 450 further receive control input from the near-end side signal parameters 460, which are generated by partial/full decoder 333 (FIG. 3). Other modifications and variations will be apparent to one skilled in the art regarding the implementation of the functionality in bit stream processor 332 (334) and are contemplated by the teachings herein. For example, sub-processing units 420, 430, 440, and 450 may be integrated or otherwise combined so as to reduce the computational complexity. Furthermore, a system may not have all four sub-processing units 420, 430, 440, and 450, but instead may include selected ones of the units in different combinations, e.g., a single unit, two or three units, and so on.

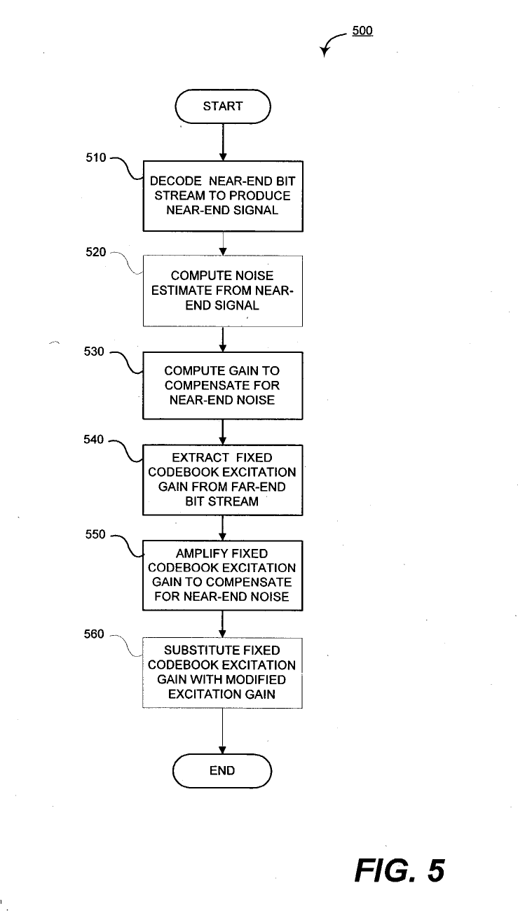

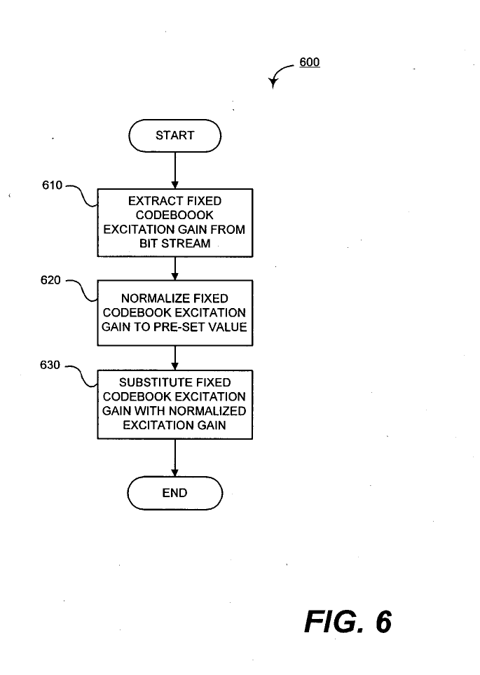

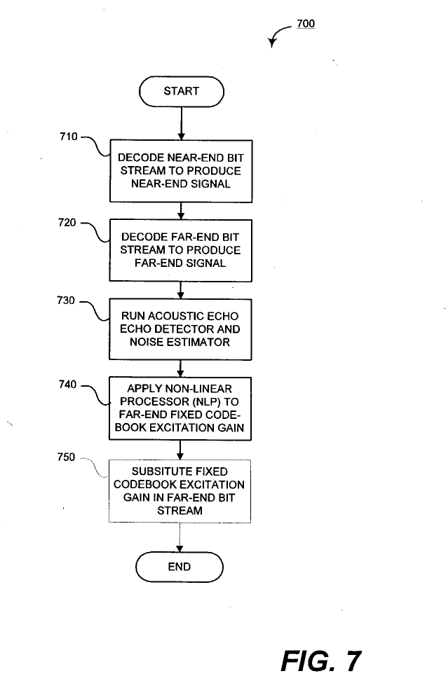

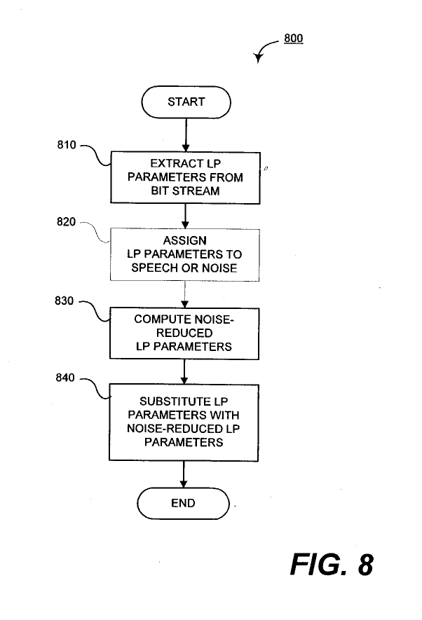

FIGS. 5, 6, 7, and 8 show exemplary logic flow diagrams for each of the functions carried out by sub-processing units 420, 430, 440, 450 in FIG. 4. In particular, FIG. 5 shows an exemplary embodiment for the noise compensation function (450), FIG. 6 shows an exemplary embodiment for the automatic level control function (440), FIG. 7 shows an exemplary embodiment for the acoustic echo control function (430), and FIG. 8 shows an exemplary embodiment for the noise reduction function (420).

More specifically, FIG. 5 illustrates an exemplary routine 500 for bit stream noise compensation unit 450 (FIG. 4) in a communications system according to one illustrative embodiment of the invention. For clarity, the task of partial/full decoders 331 and 333 (from FIG. 3) are included in the flow diagram. In this exemplary embodiment, the noise compensation function requires a full decoder for the near-end bit stream and a partial decoder for the far-end bit stream.

Routine 500 begins at step 510 in which the near-end bit stream is fully decoded to produce the near-end signal. At step 520, a noise estimator of conventional design is applied to compute/derive a noise level estimate from the near-end signal. The noise compensation gain (i.e., the gain required to compensate for near-end noise) is computed at step 530 based on the noise level estimate. One simple way of computing the noise compensation gain is to set the noise compensation gain proportional to the noise level. In other words, an increase of a given number of decibels in the noise level may increase the noise compensation gain by the same number of decibels. Alternative ways of setting the noise compensation gain are described, for example, in U.S. patent application Ser. No. 09/956,954, “Noise compensation methods and systems for increasing the clarity of voice communication,” filed September 2001 by W. Etter, which is incorporated by reference herein.

At step 540, the fixed codebook excitation gain is extracted from the far-end bit stream and, at step 550, the fixed codebook excitation gain is increased (e.g., amplified) by the amount of the noise compensation gain to provide the modified fixed codebook excitation gain to compensate for the near-end noise. Finally, at step 560, the original fixed codebook excitation gain is replaced with the modified fixed codebook excitation gain.

Depending on the vocoder, step 530 may not require a complete extraction of the fixed codebook excitation gain. Instead, it may be sufficient to extract only the fixed codebook gain table indices. Accordingly, steps 540 and 550 may operate on the fixed codebook gain indices. For example, in the AMR codec, steps 530, 540, and 550 may operate directly on the fixed codebook gain table indices bits s87-s91, s137-s141, s190-s194, and s240-s244, as identified in Table 1. It should be noted that subsequent FIGS. 5, 6, and 7 illustrate a complete extraction of the fixed codebook excitation gain. However, a system may operate only on a partially extracted parameter set, such as table indices.

FIG. 6 illustrates an exemplary routine 600 for bit stream automatic level control (ALC) unit 440 (FIG. 4) in a communications system according to one illustrative embodiment of the invention. For clarity, the task of partial/full decoder 331 (FIG. 3) is included in the flow diagram. It should be noted that routine 600 in this exemplary embodiment illustrates an ALC that requires a partial decoder only. Routine 600 begins at step 610 in which the fixed codebook excitation gain is extracted from the bit-stream, which is the task of partial decoder 331 (FIG. 3). At step 620, the fixed codebook excitation gain is normalized to a pre-set value. An ALC of conventional design may be applied for this purpose. Finally, at step 630, the original fixed codebook excitation gain is replaced with the modified (i.e., normalized) fixed codebook excitation gain.

Alternatively, an ALC that requires a full decoder may be devised in the following way. First, the bit stream is fully decoded (by decoder 331 in FIG. 3) to provide the fixed codebook excitation gain and the PCM signal. An ALC of conventional design is used to derive an ALC gain, which is then applied to the fixed codebook excitation gain rather than the PCM signal. Finally, the original fixed codebook excitation gain is replaced with the modified fixed codebook excitation gain. Other modifications and variations will be apparent to one skilled in the art and are contemplated by the teachings herein.

FIG. 7 illustrates an exemplary routine 700 for bit stream acoustic echo control (AEC) unit 430 (FIG. 4) in a communications system according to one illustrative embodiment of the invention. For clarity, the task of partial/full decoders 331 and 333 (FIG. 3) are included in the flow diagram. Routine 700 begins at step 710 in which the near-end bit-stream is fully decoded to produce the near-end signal. At step 720, the far-end bit stream is fully decoded to produce the far-end signal. Next, at step 730, an acoustic echo detector and noise estimator, both of conventional design (see, e.g., C. Breining et al., “Acoustic echo control—An application of very high-order adaptive filters,” IEEE signal processing magazine, July 1999, which is incorporated by reference herein), are computed based on the near-end and far-end signals. At step 740, a non-linear processor (NLP) of conventional design is derived from the acoustic echo detector and noise estimator and applied to the far-end fixed codebook excitation gain to provide the modified far-end fixed codebook excitation gain. Finally, at step 750, the original far-end fixed codebook excitation gain is substituted with the modified far-end fixed codebook excitation gain.

FIG. 8 illustrates an exemplary routine 800 for bit stream noise reduction unit 420 (FIG. 4) in a communications system according to one illustrative embodiment of the invention. For clarity, the task of partial/full decoder 331 (FIG. 3) is included in the flow diagram. Routine 800 begins at step 810 in which the LP parameters are extracted from the bit-stream using a partial decoder (e.g., decoder 331). By way of example, the LP parameters may be represented by equivalent vocal tract parameters such as the LSF (line spectral frequency) parameters. At step 820, the LP parameters are either assigned to speech or to noise based on the their stationarity. If the LP parameters are stationary for more than one second, for example, they are assumed to be noise parameters; otherwise, they are assumed to be speech parameters. Alternatively, stationarity can be tested based on the excitation parameters. At step 830, the noise-reduced LP parameters are computed by applying a noise reduction filter of conventional design such as a Wiener or Kalman filter (see, e.g., W. Etter, “Contributions to noise suppression in monophonic speech signals”, Ph.D. dissertation No. 10210, ETH Zurich, 1993, which is incorporated by reference herein) to arrive at the modified LP parameters. Finally, at step 840, the original LP parameters are substituted with the modified (i.e., noise-reduced) LP parameters.

In general, the foregoing embodiments are merely illustrative of the principles of the invention. Those skilled in the art will be able to devise numerous arrangements and modifications, which, although not explicitly shown or described herein, nevertheless embody those principles that are within the scope of the invention. For example, the invention was described in the context of certain illustrative embodiments. While various examples were also given for possible modifications or variations to the disclosed embodiments, it is contemplated that other modifications and arrangements will also be apparent to those skilled in the art in view of the teachings herein. Accordingly, the embodiments shown and described herein are only meant to be illustrative and not limiting in any manner. The scope of the invention is limited only by the claims appended hereto.

We claim:

1. A method for processing a voice signal in a communications network, the method comprising:
in the network, modifying selected bits of a bit stream corresponding to an encoded voice signal based on at least a partially decoded portion of the bit stream.

2. The method according to claim 1, wherein decoding occurs non-intrusively in the network.

3. The method according to claim 1, wherein the network supports tandem-free operation.

4. The method according to claim 1, wherein the step of modifying includes performing voice quality enhancement by at least one of noise compensation, noise reduction, acoustic echo control, and automatic level control.

5. The method according to claim 1, wherein the step of modifying includes modifying, in the bit stream, one or more parameters selected from the group consisting of fixed codebook excitation parameters and vocal tract parameters.

6. The method according to claim 5, wherein the step of modifying includes modifying a fixed codebook excitation gain parameter in the bit stream.

7. A method for improving signal quality of an encoded voice signal transported in a transmission path in a network, the method comprising:
in the network, decoding at least a portion of a bit stream corresponding to the encoded voice signal, wherein decoding occurs non-intrusively in a path separate from the transmission path; and
modifying selected bits of the bit stream based on the decoded portion.

8. The method according to claim 7, wherein the step of modifying includes performing voice quality enhancement by at least one of noise compensation, noise reduction, acoustic echo control, and automatic level control.

9. The method according to claim 7, wherein the step of modifying includes modifying, in the bit stream, one or more parameters selected from the group consisting of fixed codebook excitation parameters and vocal tract parameters.

10. The method according to claim 9, wherein the step of modifying includes modifying a fixed codebook excitation gain parameter in the bit stream.

11. A method for improving signal quality of an encoded voice signal transported as a bit stream between two end terminals via a transmission path in a network, the method comprising:
receiving the bit stream at a network location;
routing a copy of the bit stream to a control path separate from the transmission path;
in the control path, decoding at least a portion of the bit stream to extract information; and
modifying selected bits of the bit stream as a function of the extracted information.

12. The method according to claim 11, wherein the step of modifying includes performing voice quality enhancement by at least one of noise compensation, noise reduction, acoustic echo control, and automatic level control.

13. The method according to claim 11, wherein the step of modifying includes modifying a fixed codebook excitation parameter in the bit stream.

14. The method according to claim 13, wherein the step of modifying includes modifying a fixed codebook excitation gain parameter in the bit stream.

15. The method according to claim 11, wherein the step of modifying includes modifying vocal tract parameters in the bit stream.

16. An apparatus for processing an encoded voice signal at a network location, the apparatus comprising:
a bit stream processor, located in the network, for modifying selected bits of a bit stream corresponding to the encoded voice signal based on at least a partially decoded portion of the bit stream.

17. The apparatus according to claim 16, wherein the bit stream processor is operable to perform at least one voice quality enhancement function from the group consisting of noise compensation, noise reduction, acoustic echo control, and automatic level control.

18. The apparatus according to claim 16, wherein the bit stream processor is operable to modify, in the bit stream, one or more parameters selected from the group consisting of fixed codebook excitation parameters and vocal tract parameters.

19. The apparatus according to claim 18, wherein the step of modifying includes modifying a fixed codebook excitation gain parameter in the bit stream.

20. An apparatus for improving signal quality of an encoded voice signal transported as a bit stream between two end terminals via a transmission path in a network, the apparatus comprising:
a decoder, located in the network, for decoding at least a portion of the bit stream, wherein the decoder operates non-intrusively in a path separate from the transmission path; and
a bit stream processor, located in the network, for modifying selected bits of the bit stream based on information from the decoded portion.

21. The apparatus according to claim 20, wherein the bit stream processor is operable to perform at least one voice quality enhancement function from the group consisting of noise compensation, noise reduction, acoustic echo control, and automatic level control.

22. The apparatus according to claim 20, wherein the bit stream processor is operable to modify a fixed codebook excitation parameter in the bit stream.

23. The apparatus according to claim 22, wherein the bit stream processor is operable to modify a fixed codebook excitation gain parameter in the bit stream.

24. The apparatus according to claim 20, wherein the bit stream processor is operable to modify vocal tract parameters in the bit stream.

25. The apparatus according to claim 20, wherein the bit stream processor includes one or more processors for processing a near-end and a far-end signal and wherein the decoder includes one or more decoding elements for decoding a near-end and a far-end signal.

26. An apparatus for adjusting signal quality of an encoded voice signal transported as a bit stream between two end terminals via a transmission path in a network, the apparatus comprising:
a means for decoding at least a portion of the bit stream, wherein the decoder operates non-intrusively in a path in the network separate from the transmission path; and
in the network, a means for modifying selected bits of the bit stream based on information from the decoded portion.

27. A method for improving voice signal quality in a communications network, the network including at least a first transmission path for carrying a first bit stream corresponding to a first encoded voice signal and a second transmission path for carrying a second bit stream corresponding to a second encoded voice signal, the method comprising:
in the network, modifying selected bits of the first bit stream based on at least a partially decoded portion of at least one of the first bit stream and the second bit stream.

28. The method according to claim 27, wherein the step of modifying includes performing voice quality enhancement by at least one of noise compensation, noise reduction, acoustic echo control, and automatic level control.

29. The method according to claim 27, wherein the step of modifying includes modifying, in the first bit stream, one or more parameters selected from the group consisting of fixed codebook excitation parameters and vocal tract parameters.

30. In a communications network including at least a first transmission path for carrying a first bit stream corresponding to a first encoded voice signal and a second transmission path for carrying a second bit stream corresponding to a second encoded voice signal, a method comprising:
in the network, decoding at least a portion of the first bit stream and at least a portion of the second bit stream; and
in the network, modifying selected bits of the first bit stream based on information from at least one of the decoded portions of the first and second bit streams.
